(19) United States
(12) Patent Application Publication
(10) Pub. No.: US 2012/0305835 A1
(43) Pub. Date: Dec. 6, 2012

(54) POSITIVE ELECTRODE ACTIVE MATERIAL FOR LITHIUM SECONDARY BATTERY

(76) Inventor: Hiroyuki Yamaguchi, Susono-shi (JP)

(21) Appl. No.: 13/576,998

(22) PCT Filed: Feb. 12, 2010
(86) PCT No.: PCT/JP2010/052079

§ 371 Date: Aug. 3, 2012

(51) Int. Cl. H01M 4/525

(52) U.S. Cl. 252/182.1

(57) ABSTRACT

A positive electrode active material for a lithium secondary battery provided by the present invention is obtained by mixing a nickel-containing lithium-manganese complex oxide having a spinel structure and an aluminum- and/or magnesium-containing lithium-nickel complex oxide having a lamellar structure. The lamellar-structure lithium-nickel complex oxide is a compound represented by general formula LiNi_{1-x-y}M1ₓM2_{y}O₂ (wherein M1 is Al and/or Mg; M2 is at least one metal element selected from the group consisting of Co, Fe, Cu and Cr; 0.3≦x≦0.5; and 0≦y≦0.2).

### TECHNICAL FIELD

The present invention relates to a positive electrode active material. More particularly, the present invention relates to a positive electrode active material for a lithium secondary battery in which capacity degradation upon charge and discharge at high potential is suppressed.

### BACKGROUND ART

Lithium secondary batteries (typically, lithium ion batteries) in which charge and discharge take place through exchange of lithium ions between a positive electrode and a negative electrode are lightweight and deliver high output, and the demand of such batteries, as power sources installed in vehicles and power sources for personal computers and portable terminals, is expected to keep on growing steadily. Batteries for such applications are required to be ever smaller and lighter. Accordingly, increasing the energy density of batteries has become a major technical issue. Raising the operating voltage of the battery is an effective way of enhancing energy density. At present, a lamellar-structure lithium-cobalt complex oxide (LiCoO₂), a lamellar-structure lithium-nickel complex oxide (LiNiO₂), a spinel-structure lithium-manganese complex oxide (LiMn₂O₄) and the like can be conceivably used as positive electrode active materials that can make up a 4 V-class lithium secondary battery. However, yet higher energies could be achieved through the development of positive electrode active materials at higher potentials.

To that end, a positive electrode active material of a spinel-structure nickel-containing lithium-manganese complex oxide in which part of manganese in LiMn₂O₄ is replaced by Ni is currently under study. It is expected that this complex oxide, having for instance a composition LiMn_{1.5}Ni_{0.5}O₄, should afford a voltage operation region of 4.5 V or higher, thanks to the presence of nickel, and has thus potential as a positive electrode active material that can deliver high capacity and high energy density. Ordinarily, positive electrodes that use a spinel-structure lithium-manganese complex oxide suffer from the problem of Mn leaching upon charge and discharge at high temperature. The leaching Mn causes deterioration of the negative electrode active material and the electrolyte solution, and results in a drop of battery capacity. Therefore, batteries that use such spinel-structure lithium-manganese complex oxides in the positive electrode were problematic in that capacity dropped, and cycle characteristic was impaired as soon as the batteries were charged and discharged at high temperature.

In order to improve the cycle characteristic, it has been proposed to mix a lamellar-structure lithium-nickel complex oxide into a spinel-structure lithium-manganese complex oxide. For instance, Patent Literature 1 discloses the feature of using a mixture of a lamellar-structure lithium-nickel complex oxide represented by LiNi₁₋ₓMₓO₂ into a spinel-structure lithium-manganese complex oxide represented by (LiₓMn_{y}M_{z})₃O_{4+δ}. In the above publication, mixing of LiNi₁₋ₓMₓO₂ has the effect of suppressing, for instance, leaching of Mn, and of affording a lithium secondary battery that exhibits no capacity degradation at high temperature. Patent Literatures 2 and 3 as well disclose conventional technologies relating to mixing of such nickel-based positive electrode materials.

### CITATION LIST

### Patent Literature

Patent Literature 1: Japanese Patent Application Publication No. 2005-251713
Patent Literature 2: Japanese Patent Application Publication No. 2000-251892
Patent Literature 3: Japanese Patent Application Publication No. 2002-208441

However, the lithium secondary batteries disclosed in Patent Literatures 1 to 3 utilize all a 4 V-class spinel-structure lithium-manganese complex oxide, but none of the documents discloses the feature of using the battery at an operating voltage of 4.5 V or higher. Stability as a compound drops, and crystal structure collapses, when a lamellar-structure lithium-nickel complex oxide such as LiNiO₂ is used at a high charge and discharge potential. Therefore, even if the above lamellar-structure lithium-nickel complex oxide is mixed into a 5 V-class spinel-structure lithium-manganese complex oxide for the purpose of cycle characteristic improvement, cycle characteristic may yet fail to improve in some instances on account of a collapse of the lamellar-structure lithium-nickel complex oxide, when used at a higher charge and discharge potential. The inventors actually mixed LiNi_{0.8}Co_{0.14}Al_{0.05}O₂ into LiNi_{0.5}Mn_{1.5}O₄ and found that no practicable cycle characteristic could be achieved upon charge and discharge at 4.9 V.

### SUMMARY OF INVENTION

In the light of the above, it is a main object of the present invention to provide a positive electrode active material for a lithium secondary battery in which capacity degradation upon charge and discharge at high potential is suppressed.

Ordinarily, stability as a compound drops, and crystal structure collapses, when a lamellar-structure lithium-nickel complex oxide represented by LiNiO₂ is used at a high charge and discharge potential. The inventors found that, by contrast, the crystal structure is stabilized, and the compound exists stably even when used at high potential, by replacing part of nickel in LiNiO₂ by aluminum and/or magnesium.

The inventors found that performance degradation caused by Mn leaching from the spinel-structure lithium-manganese complex oxide was suppressed when the lamellar-structure lithium-nickel complex oxide having been thus stabilized for high potential was used by being mixed into a 5 V-class spinel-structure lithium-manganese complex oxide such as LiNi_{0.5}Mn_{1.5}O₄; as a result, it was possible to improve the cycle characteristic of a battery that contains the above positive electrode active material. The present invention was thus arrived at on the basis of that finding.

Specifically, the positive electrode active material for a lithium secondary battery provided by the present invention contains

a nickel-containing lithium-manganese complex oxide having a spinel structure; and an aluminum- and/or magnesium-containing lithium-nickel complex oxide having a lamellar structure and represented by the following general formula:

LiNi_{1-x-y}M1ₓM2_{y}O₂ (1).

In formula (1) above, M1 is Al and/or Mg. Compound stability at high potential can be increased thanks to the presence of Al and/or Mg. Preferably, M1 in (1) above is Al. Herein, Al is particularly preferred from the viewpoint of low cost and ease of synthesis.

The content proportion of M1 (i.e. the value of x in formula (1)) is 0.3≦x≦0.5. If the proportion of M1 is too small (x<0.3), the structure stabilization effect afforded by the presence of M1 may fail to be sufficiently elicited. If, by contrast, the proportion of M1 is excessive (0.5<x), unreacted product may remain during synthesis, giving rise to impurities. Therefore, the content proportion of M1 is appropriately about 0.3 or greater. Ordinarily, the content proportion is preferably 0.35 or greater; more preferably, for instance, 0.4 or greater. Preferably, M1 (Al and/or Mg) is incorporated at a composition ratio such that, typically, 0.4≦x≦0.5.

As a result there can be obtained a compound excellent in structure stability at high potential, as compared with a conventional lamellar-structure lithium-nickel complex oxide (typically, LiNiO₂) that contains no M1 (Al and/or Mg), or contains M1 at a content proportion smaller than 0.3. Thus, the lamellar-structure lithium-nickel complex oxide having been thus stabilized for high potential is used by being mixed into the 5 V-class spinel-structure nickel-containing lithium-manganese complex oxide, so that, as a result, it becomes possible to suppress performance degradation that occurs as a result of Mn leaching out of the spinel-structure lithium-manganese complex oxide, without collapse of the structure of the lamellar-structure lithium-nickel complex oxide, even when used at a high charge and discharge potential. Therefore, a lithium secondary battery can be constructed that has a superior cycle characteristic and in which capacity degradation upon charge and discharge at high potential (for instance, at 4.5 V or higher) can be suppressed, thanks to the use of such a positive electrode active material.

In formula (1), M2 is at least one metal element selected from the group consisting of Co, Fe, Cu and Cr. That is, the lamellar-structure lithium-nickel complex oxide of the present invention comprises a predetermined proportion of Al and/or Mg, but allows for the presence of at least one minor additive element selected from the group consisting of Co, Fe, Cu and Cr (the minor additive element may be absent). The content proportion of M2 (i.e. the value of x in formula (1)) can be about 0≦y≦0.2.

In a preferred aspect of the positive electrode active material disclosed herein, the proportion of the lamellar-structure lithium-nickel complex oxide with respect to the total mass of the lamellar-structure lithium-nickel complex oxide and the spinel-structure lithium-manganese complex oxide ranges from 1 mass % to 20 mass %. If the mixing proportion of the lamellar-structure lithium-nickel complex oxide is too small (typically, less than 1 mass %), then the cycle characteristic improvement effect afforded by the lamellar-structure lithium-nickel complex oxide may fail to be sufficiently elicited. If the mixing proportion of the lamellar-structure lithium-nickel complex oxide, by contrast, is excessive (typically, above 20 mass %), the battery capacity tends to drop. Therefore, the mixing proportion of the lamellar-structure lithium-nickel complex oxide ranges appropriately from about 1 mass % to 20 mass %. Preferably, the lamellar-structure lithium-nickel complex oxide is incorporated so as to yield ordinarily a mixing proportion that ranges preferably from 3 mass % to 20 mass %, for instance from 5 mass % to 15 mass % (for example, about 10 mass %).

In a preferred aspect of the positive electrode active material disclosed herein, the spinel-structure lithium-manganese complex oxide is a compound represented by general formula below.

LiₐNi_{b}Mn_{2-b-c}M3_{c}O_{4+δ} (2)

The content proportion of Ni (i.e. the value of b in formula (2)) above is 0.2≦b≦1.0. Incorporating thus Ni in such a proportion allows realizing a voltage operation region of 4.5 V or higher. In the above formula, M3 is at least one metal element selected from the group consisting of Na, K, Mg, Ca, Ti, Zr, B, Al, Si and Ge. That is, the spinel-structure lithium-manganese complex oxide of the present invention comprises a predetermined proportion of Ni, but allows for the presence of at least one minor additive element selected from the group consisting of Na, K, Mg, Ca, Ti, Zr, B, Al, Si and Ge (the minor additive element may be absent). The content proportion of M3 (i.e. the value of c in formula (2) above) may be about 0≦c<1.0.

The present invention succeeds in providing a lithium secondary battery (typically, a lithium ion secondary battery) the positive electrode whereof comprises any one of the positive electrode active materials disclosed herein. Such a lithium secondary battery is constructed using the above-described positive electrode active material in the positive electrode, and hence, a lithium secondary battery can be thus obtained that boasts better battery characteristics. For instance, a lithium secondary battery can be obtained that has a superior cycle characteristic (in particular, cycle characteristic at high temperature), with little capacity degradation even when used at a high potential such that the positive electrode potential at end-of-charge is 4.5 V or higher with respect to lithium.

Such a lithium secondary battery exhibits little charge and discharge cycle impairment even when used at a high temperature. Therefore, the performance of the battery makes the latter suitable for installation in vehicles envisaged to be used in harsh-temperature environments, for instance outdoor parking. Therefore, the present invention provides a vehicle that comprises the lithium secondary battery disclosed herein (typically, in the form of a battery pack in which a plurality of the lithium secondary batteries is electrically connected to each other). In particular, the present invention provides a vehicle (for instance, an automobile) equipped with the lithium secondary battery as a source of power (typically, a source of power in a hybrid vehicle or electric vehicle).

### BRIEF DESCRIPTION OF DRAWINGS

FIG. 1 is a diagram illustrating schematically a lithium secondary battery according to an embodiment of the present invention;

FIG. 2 is a diagram illustrating schematically an electrode body of a lithium secondary battery according to an embodiment of the present invention;

FIG. 4 is a diagram illustrating schematically a test coin cell according to a test example; and

FIG. 3 is a side-view diagram illustrating schematically a vehicle provided with a lithium secondary battery according to an embodiment of the present invention.

### DESCRIPTION OF EMBODIMENTS

Embodiments of the present invention are explained below with reference to accompanying drawings. In the drawings, members and sites that elicit identical effects are denoted with identical reference numerals. The dimensional relationships (length, width, thickness and so forth) in the drawings do not reflect actual dimensional relationships. Any features other than the features specifically set forth in the present description and which may be necessary for carrying out the present invention (for instance, the configuration and production method of an electrode body that comprises a positive electrode and a negative electrode, the configuration and production method of a separator and an electrolyte, as well as ordinary techniques relating to the construction of lithium secondary batteries and other batteries) can be regarded as design matter for a person skilled in the art on the basis of known techniques in the technical field in question.

The positive electrode active material provided by the present invention is a positive electrode active material for a lithium secondary battery that is obtained by mixing a nickel-containing lithium-manganese complex oxide having a spinel structure, and a lithium-nickel complex oxide having a lamellar structure.

<Spinel Structure Lithium-Manganese Complex Oxide>

A first positive electrode active material that makes up the positive electrode active material for a lithium secondary battery of the present embodiment is a nickel-containing lithium-manganese complex oxide having a spinel structure, represented by general formula LiₐNi_{b}Mn_{2-b-c}M3_{c}O_{4+δ} (where M3 is at least one metal element selected from the group consisting of Na, K, Mg, Ca, Ti, Zr, B, Al, Si and Ge; 0.9≦a≦1.2, 0.2≦b≦1.0, 0≦c<1.0 and 0≦δ≦0.5).

The lithium-manganese complex oxide has LiMn₂O₄ as a base, and part of the manganese in the crystal is replaced by nickel, for the purpose of characteristic improvement as an active material. The content proportion of Ni (i.e. the value of b in the formula above) is 0.2≦b≦1.0. Incorporating thus Ni in such a proportion allows realizing a voltage operation region of 4.5 V or higher, and makes it possible to construct a 5 V-class lithium secondary battery. In the above formula, M3 is at least one metal element selected from the group consisting of Na, K, Mg, Ca, Ti, Zr, B, Al, Si and Ge. That is, the spinel-structure lithium-manganese complex oxide of the present invention comprises a predetermined proportion of Ni, but allows for the presence of at least one minor additive element selected from the group consisting of Na, K, Mg, Ca, Ti, Zr, B, Al, Si and Ge (the minor additive element may be absent). The content proportion of M3 (i.e. the value of c in formula (2) above) may be about 0≦c<1.0.

The spinel-structure lithium-manganese complex oxide (LiₐNi_{b}Mn_{2-b-c}M3_{c}O₄₊δ) disclosed herein can be synthesized in accordance with a solid-phase method or liquid-phase method, in the same way as a similar conventional complex oxide. In a case where a solid-phase method is used, the spinel-structure lithium-manganese complex oxide can be synthesized by mixing, to a predetermined molar ratio, various supply sources (Li supply source, Ni supply source and Mn supply source) appropriately selected in accordance with the constituent elements of the complex oxide, and then firing the mixture by appropriate means. Typically, firing is followed by pulverization and granulation by appropriate means, as a result of which there can be prepared a powdery complex oxide having a desired average particle size and desired particle size distribution. The various supply sources (Ni supply source, Mn supply source and M3 supply source) may, in some instances, remain as impurities, on account of nonuniform element diffusion during firing. Therefore, it is also possible to dissolve the various supply sources in an appropriate solution, and to elicit thereafter precipitation of a complex carbonate, complex hydroxide, complex sulfate, complex nitrate or the like comprising the various elements (Ni, Mn and so forth), so that the obtained precipitate mixture is used as a starting material. After addition of a Li supply source, the whole is fired by an appropriate means, to yield the abovementioned spinel-structure lithium-manganese complex oxide.

For instance, a lithium compound such as lithium carbonate, lithium hydroxide or the like can be used as the lithium supply source. Nickel supply sources and manganese supply sources that can be selected include, for instance, hydroxides and oxides, as well as various salts (for instance, carbonates) and halides (for instance, fluorides), having nickel and manganese as constituent elements. Examples of the nickel supply source include, although not particularly limited thereto, nickel carbonate, nickel oxide, nickel sulfate, nickel nitrate, nickel hydroxide, nickel oxyhydroxide and the like. Examples of the manganese supply source include, for instance, manganese carbonate, manganese oxide, manganese sulfate, manganese nitrate, manganese hydroxide, manganese oxyhydroxide and the like.

In the case, for instance, of synthesis of the complex oxide represented by LiNi_{0.5}Mn_{1.5}O₄, a Li supply source, a Ni supply source and a Mn supply source may be weighed and mixed to yield Li:Ni:Mn=1:0.5:1.5, and the resulting mixture may be fired in air or in an atmosphere richer in oxygen than air, at a temperature of 900° C., for 5 hours, to synthesize thereby the complex oxide. Preferably, the lithium-manganese complex oxide thus obtained by firing is cooled, and is thereafter pulverized in a mill and appropriately sorted, to yield micro-particulate LiNi_{0.5}Mn_{1.5}O₄ having an average particle size ranging from about 1 to 25 μm.

<Lamellar Structure Lithium-Nickel Complex Oxide>

A second positive electrode active material that makes up the positive electrode active material for a lithium secondary battery of the present embodiment is an aluminum- and/or magnesium-containing lithium-nickel complex oxide having a lamellar structure and represented by general formula LiNi_{1-x-y}M1ₓM2_{y}O₂ (where M1 is Al and/or Mg, M2 is at least one metal element selected from the group consisting of Co, Fe, Cu and Cr; 0.3≦x≦0.5 and 0≦y≦0.2).

The lithium-nickel complex oxide has LiNiO₂ as a base, and part of the nickel in the crystal is replaced by aluminum and/or magnesium, for the purpose of stabilizing the crystal structure at high potential. That is, M1 in the above formula may be either Al or Mg used singly, or both Al and Mg used in combination. Compound stability at high potential can be increased thanks to the presence of M1 (Al and/or Mg). Particularly preferably, M1 in the above formula is Al. Herein, Al is preferred in terms of low cost and ease of synthesis.

The content proportion of M1 (i.e. the value of x in the formula) is 0.3≦x≦0.5. If the proportion of M1 is too small (x<0.3), the structure stabilization effect afforded by the presence of M1 may fail to be sufficiently elicited. If, by contrast, the proportion of M1 is excessive (0.5<x), unreacted product may remain during synthesis, giving rise to impurities. Therefore, the content proportion of M1 is appropriately about 0.3 or greater. Ordinarily, the content proportion is preferably 0.35 or greater; more preferably, for instance, 0.4 or greater. Preferably, M1 is incorporated at a composition ratio such that, typically, 0.4≦x≦0.5. As a result there can be obtained a compound excellent in structure stability at high potential, as compared with a conventional lamellar-structure lithium-nickel complex oxide (typically, LiNiO₂) that contains no M1, or contains M1 at a content proportion smaller than 0.3.

The lamellar-structure lithium-nickel complex oxide disclosed herein comprises Li, Ni and Al and/or Mg, but a minor additive element M2 other than the foregoing may also be present. As such M2 there can be selected one, two or more (typically, two or three) metal elements selected from among Co, Fe, Cu and Cr. These additional constituent elements are added in a proportion such that the sum total of the added element plus nickel and M1 is no greater than 20 atom %, preferably no greater than 10 atom %. Alternatively, no additional element need be added. That is, the content proportion of M2 (i.e. the value of y in the formula) may be set to about 0≦y≦0.2.

The lamellar-structure lithium-nickel complex oxide (LiNi_{1-x-y}M1ₓM2_{y}O₂) disclosed herein can be synthesized in accordance with a solid-phase method or liquid-phase method, in the same way as a similar conventional complex oxide. If a solid-phase method is resorted to, the lamellar-structure lithium-nickel complex oxide can be synthesized by mixing, to a predetermined molar ratio, various supply sources (Li supply source, Ni supply source, M2 supply source and M1 supply source) appropriately selected in accordance with the constituent elements of the complex oxide, and then firing the mixture by appropriate means. Typically, firing is followed by pulverization and granulation by appropriate means, as a result of which there can be prepared a powdery complex oxide having a desired average particle size and desired particle size distribution. The various supply sources (Ni supply source, M1 supply source and M2 supply source) may, in some instances, remain as impurities, on account of nonuniform element diffusion during firing. Therefore, it is also possible to dissolve the various supply sources in an appropriate solution, and elicit precipitation thereafter of a complex carbonate, complex hydroxide, complex sulfate, complex nitrate or the like comprising the various elements, so that the obtained precipitate mixture is used as a starting material. After addition of a Li supply source, the whole is fired by an appropriate means, to yield the abovementioned lamellar-structure lithium-nickel complex oxide.

As the lithium supply source and nickel supply source there can be used the same sources in the spinel-structure lithium-manganese complex oxide described above. For instance, a lithium compound such as lithium carbonate, lithium hydroxide or the like can be used as the lithium supply source. Nickel supply sources and manganese supply sources that can be selected include, for instance, hydroxides and oxides, as well as various salts (for instance, carbonates) and halides (for instance, fluorides) having nickel and manganese as constituent elements. Aluminum sources and magnesium sources and other metal supply source compounds (for instance, cobalt compounds, iron compounds, copper compounds chromium compounds) that can be selected herein include, for instance, hydroxides and oxides, as well as various salts (for instance, carbonates) and halides (for instance, fluorides) having the foregoing elements as constituent elements. Examples of aluminum supply sources include, although not particularly limited thereto, aluminum oxide, aluminum hydroxide, aluminum carbonate, aluminum acetate and the like. Examples of magnesium supply sources include, for instance, magnesium oxide, magnesium hydroxide, magnesium carbonate, magnesium acetate and the like.

In the case, for instance, of synthesis of the complex oxide represented by LiNi_{0.7}Al_{0.3}O₂, a Li supply source, a Ni supply source and an Al supply source may be weighed and mixed to yield Li:Ni:Al=1:0.7:0.3, and the resulting mixture may be fired in air or in an atmosphere richer in oxygen than air, at a temperature of 750° C., for 10 hours, to synthesize thereby the complex oxide. Preferably, the lithium-nickel complex oxide thus obtained by firing is cooled, and is thereafter pulverized in a mill and appropriately sorted, to yield micro-particulate LiNi_{0.7}Al_{0.3}O₂ having an average particle size ranging from about 1 to 25 μm.

<Mixing of the Spinel-Structure Lithium-Manganese Complex Oxide and the Lamellar-Structure Lithium-Nickel Complex Oxide>

As described above, the positive electrode active material of the present embodiment is a mixture of the spinel-structure lithium-manganese complex oxide represented by general formula LiₐNi_{b}Mn_{2-b-c}M3_{c}O_{4+δ} and the lamellar-structure lithium-nickel complex oxide represented by general formula LiNi_{1-x-y}M1ₓM2_{y}O₂, obtained in accordance with the above-described methods. The above complex oxides, after pulverizing and sorting as described above, may be mixed uniformly using a blender device or the like. Alternatively, the above mixing may be accomplished by pulverizing and sorting simultaneously the two complex oxides, using a ball mill device or the like.

In a preferred aspect of the positive electrode active material disclosed herein, the proportion of the lamellar-structure lithium-nickel complex oxide with respect to the total mass of the lamellar-structure lithium-nickel complex oxide and the spinel-structure lithium-manganese complex oxide ranges from 1 mass % to 20 mass %. If the mixing proportion of the lamellar-structure lithium-nickel complex oxide is too small (typically, less than 1 mass %), then the cycle characteristic improvement effect afforded by the lamellar-structure lithium-nickel complex oxide may fail to be sufficiently elicited. If the mixing proportion of the lamellar-structure lithium-nickel complex oxide, by contrast, is excessive (typically, above 20 mass %), battery capacity tends to drop. Therefore, the mixing proportion of the lamellar-structure lithium-nickel complex oxide ranges appropriately from about 1 mass % to 20 mass %. Preferably, the lamellar-structure lithium-nickel complex oxide is incorporated so as to yield ordinarily a mixing proportion that ranges preferably from 3 mass % to 20 mass %, for instance from 5 mass % to 15 mass % (for example, about 10 mass %).

In the positive electrode active material of the present embodiment, the lamellar-structure lithium-nickel complex oxide stabilized at high potential is used by being mixed with the 5 V-class spinel-structure lithium-manganese complex oxide. Therefore, it becomes possible to suppress performance degradation (typically, performance degradation of the negative electrode active material and the electrolyte solution) that occurs as a result of Mn leaching out of the spinel-structure lithium-manganese complex oxide, without collapse of the structure of the lamellar-structure lithium-nickel complex oxide, even when used at a high charge and discharge potential. Therefore, a lithium secondary battery can be constructed that has good cycle characteristic and in which capacity degradation upon charge and discharge at high potential (for instance, at 4.5 V or higher) can be suppressed, thanks to the use of such a positive electrode active material.

Except for the use of the positive electrode active material disclosed herein, a lithium secondary battery can be constructed using materials and in accordance with processes that are identical to conventional ones.

For instance, a conductive material in the form of carbon black such as acetylene black, Ketchen black or the like, or some other powdery carbon material (graphite or the like) may be mixed into the powder (powdery positive electrode active material) that results from mixing the spinel-structure lithium-manganese complex oxide and the lamellar-structure lithium-nickel complex oxide that are disclosed herein. Besides the positive electrode active material and the conductive material, there can also be added a binder such as polyvinylidene fluoride (PVDF), styrene butadiene rubber (SBR), polytetrafluoroethylene (PTFE), carboxymethyl cellulose (CMC) or the like. The foregoing are dispersed in an appropriate dispersion medium and are kneaded, as a result of which there can be prepared a paste-like (this includes slurry-like and ink-like, likewise hereafter) composition for forming a positive electrode active material layer (hereafter also referred to as “paste for forming a positive electrode active material layer”). A positive electrode for a lithium secondary battery can be then produced by coating an appropriate amount of this paste onto a positive electrode collector, preferably made up of aluminum or an alloy having aluminum as a main component, followed by drying and pressing.

A negative electrode for a lithium secondary battery, as a counter electrode, can be produced in accordance with a method identical to a conventional one. For instance, a material capable of storing and releasing lithium ions may be used as a negative electrode active material. Typical examples of such materials include, for instance, powdery carbon materials that comprise graphite or the like. A paste-like composition for forming a negative electrode active material layer (hereafter also referred to as “paste for forming a negative electrode active material layer”) can be prepared by dispersing such a powdery material in an appropriate binder, and by kneading, as in the case of the positive electrode. A negative electrode for a lithium secondary battery can be then produced by coating an appropriate amount of this paste onto a negative electrode collector, preferably made up of copper, nickel or an alloy of the foregoing, followed by drying and pressing.

A separator identical to conventional ones may be used in the lithium secondary battery wherein a mixture of the spinel-type lithium-manganese complex oxide and lamellar lithium-nickel complex oxide of the present invention are used in a positive electrode active material. For instance, there can be used a porous sheet (porous film) comprising a polyolefin resin.

The electrolyte used is not particularly limited and there can be used an electrolyte identical to nonaqueous electrolytes (typically, electrolyte solutions) that are used in conventional lithium secondary batteries. In a typical composition, a supporting salt is incorporated into an appropriate nonaqueous solvent. As the nonaqueous solvent there can be used one, two or more types selected from the group consisting of propylene carbonate (PC), ethylene carbonate (EC), diethyl carbonate (DEC), dimethyl carbonate (DMC), ethyl methyl carbonate (EMC) and the like. As the abovementioned supporting salt there can be used one, two or more lithium compounds (lithium salts) selected from among LiPF₆, LiBF₄, LiClO₄, LiAsF₆, LiCF₃SO₃, LiC₄F₉SO₃, LiN(CF₃SO₂)₂, LiC(CF₃SO₂)₃, LiI or the like.

The shape (outer shape and size) of the lithium secondary battery constructed is not particularly limited, so long as a mixture of the spinel-structure lithium-manganese complex oxide (LiₐNi_{b}Mn_{2-b-c}M3_{c}O_{4+δ}) and lamellar-structure lithium-nickel complex oxide (LiNi_{1-x-y}M1ₓM2_{y}O₂) disclosed herein is used as the positive electrode active material. The battery may have an exterior package of thin sheet type made up of a laminate film or the like, or may have a battery outer case that is shaped as a cylinder, or as a rectangular parallelepiped, or may have a small button shape.

An explanation follows next on an example of the way in which the positive electrode active material disclosed herein is used in a lithium secondary battery (herein, a lithium ion battery) that is provided with a wound electrode body. However, the present invention is not meant to be limited to such an embodiment.

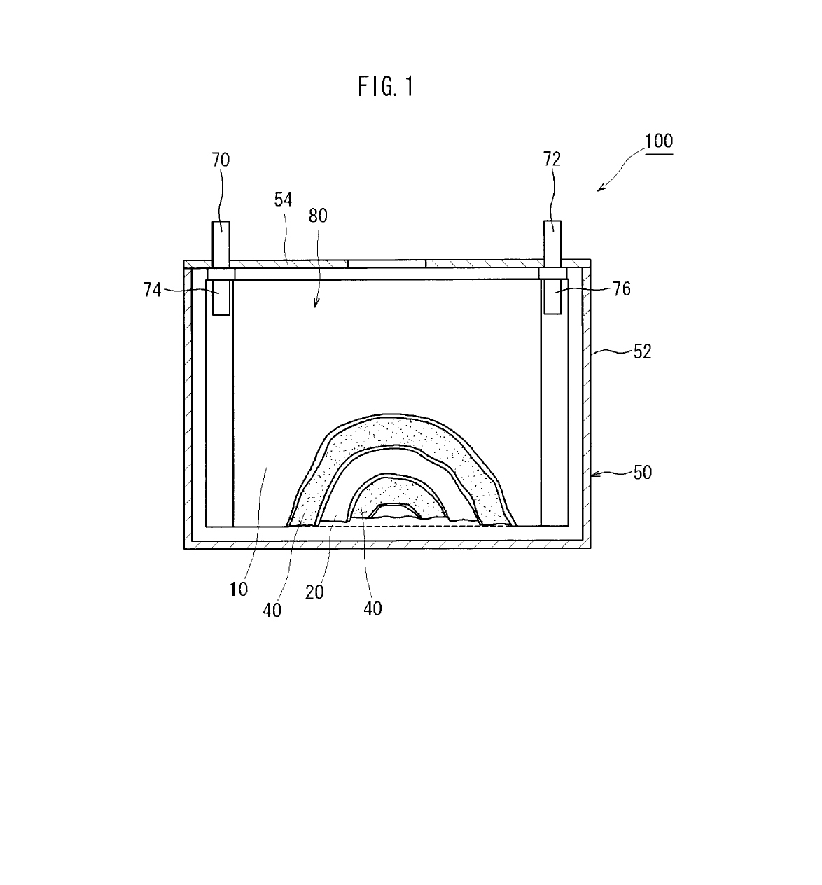

As illustrated in FIG. 1, a lithium secondary battery 100 according to the present embodiment has a configuration wherein an electrode body (wound electrode body) 80, of a form such that an elongate positive electrode sheet 10 and an elongate negative electrode sheet 20 are wound in a flat manner, with a separator 40 interposed therebetween, is accommodated in a container 50 having a shape (flat box shape) that enables the wound electrode body 80 and a nonaqueous electrolyte solution, not shown, to be accommodated in the container 50.

The container 50 is provided with a container main body 52 shaped as a flat rectangular parallelepiped and having an open top end, and with a lid body 54 that plugs the opening of the container main body 52. A metallic material such as aluminum, stainless steel or the like (in the present embodiment, aluminum) is preferably used as the material that makes up the container 50. Alternatively, the container 50 may be molded out of a resin material such as a polyphenylene sulfide resin (PPS), a polyimide resin or the like. On the top face of the container 50 (i.e. on the lid body 54) there are provided a positive electrode terminal 70 that is electrically connected to the positive electrode of the wound electrode body 80, and a negative electrode terminal 72 that is electrically connected to the negative electrode 20 of the electrode body 80. The flat-shaped wound electrode body 80 is housed, together with a nonaqueous electrolyte solution, not shown, in the interior of the container 50.

The material and members themselves that make up the wound electrode body 80 having the above configuration are not particularly limited, and may be identical to those of electrode bodies in conventional lithium ion batteries, except for the use of a positive electrode active material in the form of a mixture of the spinel-structure lithium-manganese complex oxide (LiNiₐMn₂₋ₐO₄) and a lamellar-structure lithium-nickel complex oxide (LiNi_{1-x-y}M1ₓM2_{y}O₂).

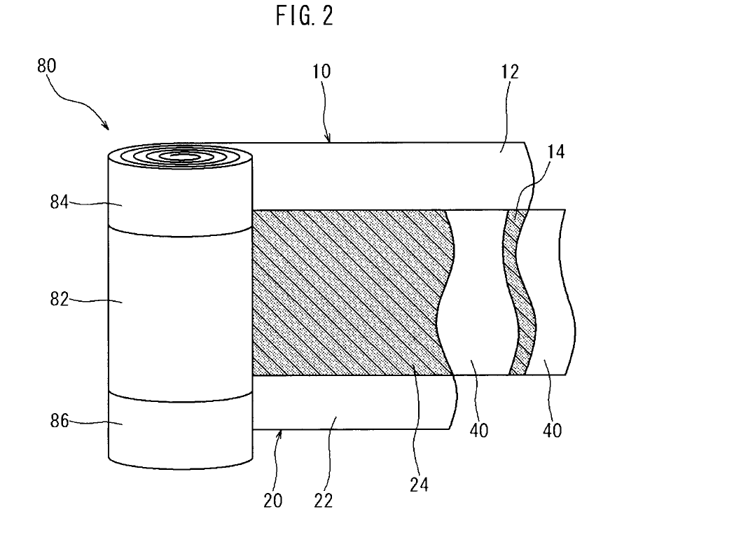

The wound electrode body 80 according to the present embodiment is identical to the wound electrode body of ordinary lithium secondary batteries. Prior to the assembly stage, the wound electrode body 80 has, as illustrated in FIG. 2, an elongated (band-like) sheet structure.

The positive electrode sheet 10 has a structure wherein a positive electrode active material layer 14 comprising a positive electrode active material is held on both faces of an elongate sheet-like foil-shaped positive electrode collector (hereafter referred to as “positive electrode conductor foil”) 12. A positive electrode active material layer non-formation section is formed such that the positive electrode active material layer 14 is not formed at one side edge, in the width direction of the positive electrode sheet 10 (lower side edge in the figure), and the positive electrode collector 12 is exposed over a given width.

The positive electrode active material layer 14 can contain, as the case may require, one, two or more types of material that can be used as constituent components in positive electrode active material layers of ordinary lithium secondary batteries. Examples of such materials include, for instance, conductive materials. A carbon material such as a carbon powder, carbon fibers or the like is preferably used as such a conductive material. Alternatively, there may be used, for instance, a conductive metal powder such as a nickel powder or the like. Other examples of materials that can be used as components of the positive electrode active material layer include, for instance, various polymer materials that can function as a binder of the abovementioned constituent materials.

As in the case of the positive electrode sheet 10, the negative electrode sheet 20 as well has a structure in which a negative electrode active material layer 24 comprising a negative electrode active material is held on both faces of an elongate sheet-like foil-shaped negative electrode collector (hereafter, referred to as negative electrode conductor foil) 22. A negative electrode active material layer non-formation section is formed such that the negative electrode active material layer 24 is not formed at one side edge, in the width direction of the negative electrode sheet 20 (upper side edge in the figure), and the negative electrode collector 22 is exposed over a given width.

The negative electrode sheet 20 can be formed by applying the negative electrode active material layer 24, having a negative electrode active material for lithium ion batteries as a main component, onto the elongate negative electrode collector 22. A copper foil, or another metal foil appropriate for negative electrodes, is suitably used in the negative electrode collector 22. The negative electrode active material is not particularly limited, and there can be used one, two or more materials that are conventionally used in lithium secondary batteries. Appropriate examples thereof include, for instance, carbon-based materials such as graphite carbon, amorphous carbon or the like, or lithium-containing transition metal oxides and transition metal nitrides.

To produce the wound electrode body 80, the positive electrode sheet 10 and the negative electrode sheet 20 are stacked with the separator sheet 40 interposed in between. Herein, the positive electrode sheet 10 and the negative electrode sheet 20 are overlaid slightly offset in the width direction, in such a manner that the positive electrode active material layer non-formation portion of the positive electrode sheet 10 and the negative electrode active material layer non-formation portion of the negative electrode sheet 20 jut beyond both sides of the separator sheet 40, in the width direction. The stack resulting from such overlaying is wound, and the obtained wound body is next squashed from the sides. The flat wound electrode body 80 can be produced as a result.

A wound core portion 82 (i.e. portion of close stacking between the positive electrode active material layer 14 of the positive electrode sheet 10, the negative electrode active material layer 24 of the negative electrode sheet 20, and the separator sheet 40) is formed at the central portion of the wound electrode body 80 in the winding axial direction. The electrode active material layer non-formation portions of the positive electrode sheet 10 and the negative electrode sheet 20 jut outward of the wound core portion 82 at respective end portions of the wound electrode body 80, in the winding axial direction. A positive electrode lead terminal 74 (FIG. 1) and a negative electrode lead terminal 76 (FIG. 1) are respectively attached to a positive electrode-side jutting portion (i.e. non-formation portion of the positive electrode active material layer 14) 84 and a negative electrode-side jutting portion (i.e. non-formation portion of the negative electrode active material layer 24) 86, the positive electrode lead terminal 74 and the negative electrode lead terminal 76 being electrically connected to the above-described positive electrode terminal 70 and negative electrode terminal 72, respectively.

The wound electrode body 80 having such a configuration is housed in the container main body 52, and an appropriate nonaqueous electrolyte solution is arranged (poured) in the container main body 52. The opening of the container main body 52 is sealed by the lid body 54, for instance through welding or the like. This completes the construction (assembly) of the lithium ion battery 100 according to the present embodiment. The sealing process of the container main body 52 and the process of arranging (pouring) electrolyte solution can be performed in accordance with methods identical to those of in the production of conventional lithium secondary batteries. Thereafter, the battery is subjected to conditioning (initial charge and discharge). Various other processes, such as degassing, quality inspection and the like may also be performed, as the case may require. The lithium secondary battery 100 configured in that above-described manner is constructed using a positive electrode active material in the form of a mixture of the above-described spinel-structure lithium-manganese complex oxide (LiₐNi_{b}Mn_{2-b-c}M3_{c}O_{4+δ}) and lamellar-structure lithium-nickel complex oxide (LiNi_{1-x-y}M1ₓM2_{y}O₂). A lithium secondary battery can be thus obtained that boasts better battery characteristics. For instance, a lithium secondary battery can be obtained that has a superior cycle characteristic (in particular, cycle characteristic at high temperature), with little capacity degradation even when used at a high potential such that the positive electrode potential at end-of-charge is 4.5 V or higher with respect to lithium.

In the test examples below, lithium secondary batteries (sample batteries) were constructed using, as a positive electrode active material, the spinel-structure lithium-manganese complex oxide and lamellar-structure lithium-nickel complex oxide disclosed herein, and the performance of the batteries was evaluated.

<Production of a Positive Electrode Active Material>

Firstly, LiMn_{1.5}Ni_{0.5}O₄ having Li:Ni:Mn at 1:0.5:1.5 was synthesized as the spinel-structure nickel-containing lithium-manganese complex oxide. Specifically, lithium carbonate as a lithium supply source, nickel oxide as a nickel supply source, and manganese oxide as a manganese supply source were mixed in such amounts as to yield a predetermined molar ratio. The mixture was fired in the atmosphere, at about 900° C., for about 5 hours. After this firing process, the fired product was pulverized, to yield thereby a powder (average particle size 7 μm) comprising a spinel-structure nickel-containing lithium-manganese complex oxide represented by LiMn_{1.5}Ni_{0.5}O₄.

The lamellar complex oxides given in Table 1 below were synthesized as the lamellar structure aluminum- and/or magnesium-containing lithium-nickel complex oxide. Specifically, lithium carbonate as a lithium supply source, nickel oxide as a nickel supply source, aluminum oxide as an aluminum supply source, magnesium oxide as a magnesium supply source, and cobalt oxide as a cobalt supply source were mixed in such amounts as to yield a predetermined molar ratio. The mixture was fired in the atmosphere, at about 750° C., for about 10 hours. After this firing process, the fired product was pulverized, to yield thereby a respective powder (average particle size 5 μm) comprising each lamellar-structure lithium-nickel complex oxide given Table 1.

Positive electrode active materials were then obtained by mixing the above powder (A) of spinel-structure lithium-manganese complex oxide and the above powder (B) of lamellar-structure lithium-nickel complex oxide, so as to yield the mass ratios (A/B) given in Table 1.

TABLE 1

| | Spinel structure | Lamellar structure | | Initial discharge | Discharge capacity | Discharge capacity |
|---|---|---|---|---|---|---|
| | complex | complex | Mass ratio | capacity | retention rate (%) | retention rate (%) |
| | oxide A | oxide B | (A/B) | (mAh/g) | after 100 cycles, 25° C. | after 50 cycles, 60° C. |
| Sample 1 | LiNi_{0.5}Mn_{1.5}O₄ | LiNi_{0.7}Al_{0.3}O₂ | 90/10 | 124 | 72 | 30 |
| Sample 2 | LiNi_{0.5}Mn_{1.5}O₄ | LiNi_{0.7}Al_{0.3}O₂ | 95/5 | 125 | 71 | 25 |
| Sample 3 | LiNi_{0.5}Mn_{1.5}O₄ | LiNi_{0.7}Al_{0.3}O₂ | 80/20 | 122 | 73 | 35 |
| Sample 4 | LiNi_{0.5}Mn_{1.5}O₄ | LiNi_{0.5}Al_{0.5}O₂ | 90/10 | 122 | 71 | 34 |
| Sample 5 | LiNi_{0.5}Mn_{1.5}O₄ | LiNi_{0.6}C0_{0.1}Al_{0.3}O₂ | 90/10 | 125 | 71 | 32 |
| Sample 6 | LiNi_{0.5}Mn_{1.5}O₄ | LiNi_{0.7}Al_{0.2}Mg_{0.1}O₂ | 90/10 | 123 | 73 | 34 |
| Sample 7 | LiNi_{0.5}Mn_{1.5}O₄ | LiNi_{0.8}Co_{0.15}Al_{0.05}O₂ | 90/10 | 119 | 70 | 20 |
| Sample 8 | LiNi_{0.5}Mn_{1.5}O₄ | — | 100/0 | 122 | 57 | 10 |
| Sample 9 | LiNi_{0.5}Mn_{1.5}O₄ | Li_{1.1}Ni_{0.33}Mn_{0.57}O₂ | 90/10 | 135 | 53 | 10 |

<Production of a Positive Electrode>

Each obtained positive electrode active material powder (mixture of the powder of spinel-type lithium-manganese complex oxide and a powder of lamellar-structure lithium-nickel complex oxide), plus acetylene black as a conductive material and polyvinylidene fluoride (PVDF) as a binder, were weighed so as to yield a mass ratio of positive electrode active material, acetylene black and PVDF of 85:10:5, and were mixed homogeneously in N-methylpyrrolidone (NMP), to prepare a paste-like composition for forming a positive electrode active material layer. This paste-like composition for forming a positive electrode active material layer was coated, in the form of a layer, onto one face of an aluminum foil (positive electrode collector: thickness 15 μm), and was dried, to yield a positive electrode sheet having a positive electrode active material layer provided on one face of the positive electrode collector.

<Production of a Negative Electrode>

Graphite powder as a negative electrode active material and polyvinylidene fluoride (PVDF) as a binder were weighed, to yield a mass ratio of negative electrode active material to PVDF of 92.5:7.5, and were homogeneously mixed in N-methylpyrrolidone (NMP), to prepare a paste-like composition for forming a negative electrode active material layer. This paste-like composition for forming a negative electrode active material layer was coated, in the form of a layer, onto one face of a copper foil (negative electrode collector: thickness 15 μm), and was dried, to yield a negative electrode sheet having a negative electrode active material layer provided on one side of the negative electrode collector.

<Production of a Coin Cell>

Each positive electrode sheet obtained as described above was punched to a circular shape having a diameter of 1.6 mm, to produce a pellet-like positive electrode. Each negative electrode sheet obtained above was punched to a circular shape having a diameter of 1.9 mm, to produce a pellet-like negative electrode. The positive electrode, the negative electrode and a separator (herein there was used a porous sheet having a diameter of 22 mm and a thickness of 0.02 mm, and comprising a three-layer structure (polypropylene (PP)/polyethylene (PE)/polypropylene (PP)) were assembled into a stainless steel collector, together with a nonaqueous electrolyte solution, to construct a coin cell 60 (half cell for charge and discharge performance evaluation) having a diameter of 20 mm and a thickness of 3.2 mm (2032 type) illustrated in FIG. 3. In FIG. 3, the reference numeral 61 denotes a positive electrode, the reference numeral 62 denotes a negative electrode, the reference numeral 63 denotes a separator impregnated with an electrolyte solution, the reference numeral 64 denotes a gasket, the reference numeral 65 denotes a container (negative electrode terminal) and the reference numeral 66 denotes a lid (positive electrode terminal). The nonaqueous electrolyte solution used contained about 1 mol/liter of LiPF₆, as a supporting salt, in a mixed solvent of ethylene carbonate (EC) and diethyl carbonate (DEC) at a 3:7 volume ratio. A lithium secondary battery (test coin cell) 60 was thus produced.

<Charge and Discharge Cycle Test>

The test coin cells obtained as described above were charged up to 4.9 V at 0.1 C constant current under temperature conditions of 25° C. Next, the cells were discharged down to 3.4 V at 0.1 C constant current. This charge and discharge cycle was repeated three times.

Next, each battery after the three cycles of 0.1 C charge and discharge, as described above, was charged, up to total charge time of 2 hours, according to a constant-current, constant-voltage scheme of 1 C current and 4.9 V voltage, under temperature conditions of 25° C., Next, the cell was discharged down to 3.4 V at 0.1 C constant current. This charge and discharge cycle was repeated 100 times. A discharge capacity retention rate after 100 cycles (“100th cycle discharge capacity/1st cycle discharge capacity (initial discharge capacity)”×100) was calculated on the basis of the ratio of the 1st cycle discharge capacity (initial discharge capacity) and the 100th cycle discharge capacity.

Using a different coin cell produced in the same way as described above, a battery after three cycles of 0.1 C charge and discharge as described above was charged, up to a total charge time of 2 hours, according to a constant-current, constant-voltage scheme of 1 C current and 4.9 V voltage, under temperature conditions of 60° C. Next, the cells were discharged down to 3.4 V at 1 C constant current. This charge and discharge cycle was repeated 50 times. A discharge capacity retention rate after 50 cycles (“50th cycle discharge capacity/1st cycle discharge capacity (initial discharge capacity)”×100) was calculated on the basis of the ratio of the 1st cycle discharge capacity (initial discharge capacity) and the 50th cycle discharge capacity. The results are given in Table 1.

As Table 1 shows, the test cells (samples 1 to 7), wherein lamellar structure Al-containing lithium-nickel complex oxides were mixed into LiNi_{0.5}Mn_{1.5}O₄ exhibited clearly increased discharge capacity retention rate at 25° C. vis-à-vis the test cells (samples 8 and 9) in which no lamellar structure Al-containing lithium-nickel complex oxide was mixed. The test cells (samples 1 to 5) in which the Al content proportion was adjusted to range from 0.3 to 0.5 exhibited significantly improved discharge capacity retention rate at 60° C. vis-à-vis a test cell (sample 7) in which the Al content proportion was adjusted to be smaller than 0.3. In particular, a very high 60° C. discharge capacity retention rate, of 30% or higher, could be realized by adjusting the Al content proportion to range from 0.3 to 0.5, and by setting the mixing proportion of the lamellar structure Al-containing lithium-nickel complex oxide to range from 10 mass % to 20 mass %. The foregoing indicated that the cycle characteristic (in particular, cycle characteristic at high temperature) could be improved in a preferable manner by adjusting the Al content proportion to range from 0.3 to 0.5, and by setting the mixing proportion of the lamellar structure Al-containing lithium-nickel complex oxide to range from 10 mass % to 20 mass %.

A test cell obtained in the test example and in which there was mixed a lamellar-structure lithium-nickel complex oxide containing Mg in addition to Al (sample 6) exhibited substantially the same performance as the test cells (samples 1 to 5) in which there was mixed a lamellar-structure lithium-nickel complex oxide containing Al alone. This indicated that the same effect as elicited through the presence of Al could be elicited by incorporating Mg into the lamellar-structure lithium-nickel complex oxide. A test cell obtained in the present test example and in which there was mixed a Al-containing lamellar-structure lithium-nickel complex oxide that contained cobalt (sample 5) exhibited substantially the same performance as the test cells (samples 1 to 4) in which there was mixed an Al-containing lamellar-structure lithium-nickel complex oxide comprising no cobalt. It was found, as a result, that it was possible further incorporate an additional metal element, such as Co, in a proportion no greater than 20 atom % (preferably, no greater than 10 atom %) of the total constituent metal elements, other than lithium, in the Al-containing lamellar-structure lithium-nickel complex oxide.

The present invention has been explained above on the basis of preferred embodiments, but the features disclosed are not limiting features in any way, and, needless to say, may accommodate various modifications.

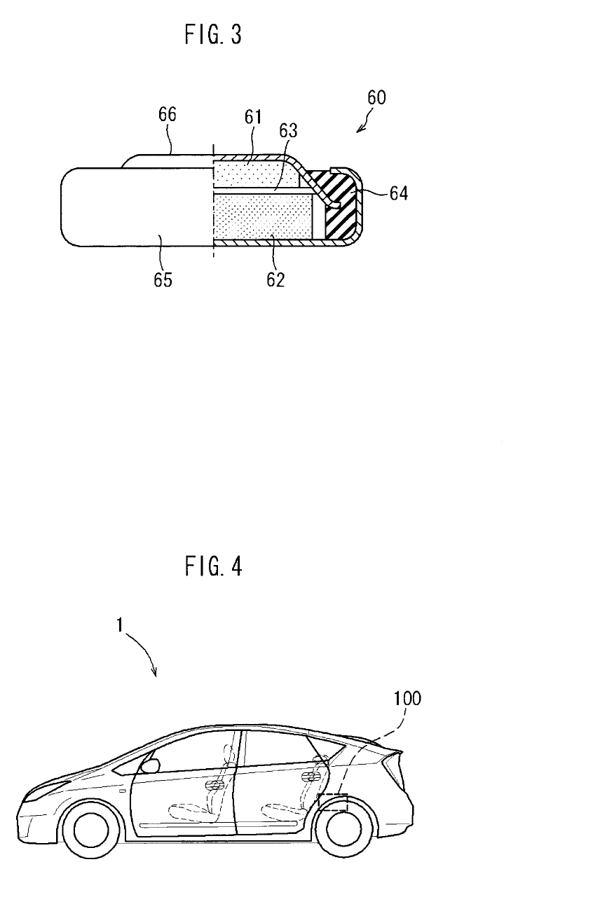

As described above, any of the lithium secondary batteries 100 disclosed herein exhibits little charge and discharge cycle impairment even when used at high temperature. Therefore, the performance of the batteries makes the latter suitable for installation in vehicles envisaged to be used in harsh-temperature environments, for instance outdoor parking. Therefore, the present invention provides a vehicle 1 that is equipped with the lithium secondary battery 100 disclosed herein (which may be embodied in the form of a battery pack of a plurality of lithium secondary batteries connected to each other), as illustrated in FIG. 4. In particular, the present invention provides a vehicle (for instance, an automobile) equipped with the lithium secondary battery as a source of power (typically, a source of power in a hybrid vehicle or electric vehicle).

### INDUSTRIAL APPLICABILITY

The present invention succeeds in providing a positive electrode active material having little performance degradation caused by Mn leaching. Through the use of such a positive electrode active material, therefore, a lithium secondary battery can be provided that has a superior cycle characteristic. In particular, there can be provided a lithium secondary battery having a superior cycle characteristic at high temperature (for instance, an automotive lithium secondary battery that is used as a power source for driving a vehicle).

1. A lithium secondary battery, comprising, in a positive electrode, a positive electrode active material that is obtained by mixing a nickel-containing lithium-manganese complex oxide having a spinel structure, and a lithium-nickel complex oxide having a lamellar structure and represented by the following general formula:
LiNi_{1-x-y}M1ₓM2_{y}O₂
(wherein M1 is Al and Mg; M2 is at least one metal element selected from the group consisting of Co, Fe, Cu and Cr; 0.3≦x≦0.5; and 0≦y≦0.2).

2. The lithium secondary battery according to claim 1, wherein the mixing proportion of the lamellar-structure lithium-nickel complex oxide with respect to the total mass of the lamellar-structure lithium-nickel complex oxide and the spinel-structure lithium-manganese complex oxide ranges from 1 mass % to 20 mass %.

3. The lithium secondary battery according to claim 1, wherein the spinel-structure lithium-manganese complex oxide is a compound represented by general formula:
LiₐNi_{b}Mn_{2-b-c}M3_{c}O_{4+δ}
(where M3 is at least one metal element selected from the group consisting of Na, K, Mg, Ca, Ti, Zr, B, Al, Si and Ge; 0.9≦a≦1.2; 0.2≦b≦1.0; 0≦c<1.0 and 0≦δ≦0.5).

4. The lithium secondary battery according to claim 1, wherein a positive electrode potential at end-of-charge is 4.5 V or higher with respect to lithium.

5. A vehicle, comprising the lithium secondary battery according to claim 1.
